(19) United States
(12) Patent Application Publication
(10) Pub. No.: US 2004/0035102 A1
(43) Pub. Date: Feb. 26, 2004

(54) Hydrostatic transmission

(76) Inventors: Raimund Roth, Nersingen (DE); Werner Hoermann, Illertissen (DE)

Correspondence Address: Leopold Presser, Scully Scott Murphy & Presser, 400 Garden City Plaza, Garden City, NY, 11530, US

(21) Appl. No.: 10/332,791

(22) PCT Filed: May 14, 2001
(86) PCT No.: PCT/EP01/05458

(30) Foreign Application Priority Data
Jul. 12, 2000 (DE) 100 33 739.2

(51) Int. Cl. F16D 31/02

(52) U.S. Cl. 60/413

(57) ABSTRACT

The invention relates to a hydrostatic transmission (1), comprising a hydraulic pump (2) and a hydraulic engine (3) linked with the hydraulic pump (2) via working lines. A by-pass line (6) links the high-pressure system with the low-pressure system and is connected to the high-pressure system and to the low-pressure system at branches (6a, 6b). A stop valve (7) is disposed in the by-pass line (6) and opens the by-pass line (6) when the pressure in the high-pressure system drops below the pressure in the low-pressure system. The circuit portion that extends between the branches (6a, 6b) and through the hydraulic engine (3) is longer than half the length of the entire circuit, thereby enlarging the possible applications and uses of the hydrostatic transmission (1).

The invention relates to a hydrostatic transmission according to the preamble of claim 1 or 4.

A hydrostatic transmission of said type is described in DE 38 22 149 C2 as the drive of a cooling fan for a heat exchanger of a motor vehicle. In said previously known open-circuit hydrostatic transmission there is disposed in a bypass line, which bypasses the hydraulic motor, a nonreturn valve which, in the event of a sudden drop in the rate of delivery of the hydraulic pump, enables hydraulic fluid to be fed to the delivery line of the hydraulic pump in order to avoid a damaging drop of the pressure in the delivery line. In said known construction, in the described situation of a reduction of the rate of delivery of the hydraulic pump the bypass line may form a so-called motor circuit, in which the hydraulic motor continues to operate in a free-wheeling manner, e.g. on account of its inertia mass. In such a situation the risk of overheating cannot be ruled out because the hydraulic fluid is circulated mainly only in the small motor circuit. Said known hydrostatic transmission is therefore unsuitable for applications where overheating in the hydraulic system is a factor to be reckoned with, and it is particularly unsuitable for vehicle drives, in which the pressure of the high-pressure system may drop below the pressure of the low-pressure system for an extended period, e.g. as a result of load input leading to a reversal of the function of the hydraulic motor as a hydraulic pump, such as is the case in a vehicle drive during downhill travel. But also in the situation of a sudden reduction of the rate of delivery of the hydraulic pump the known transmission is in need of improvement. There is i.a. the risk of overheating in the small motor circuit. This limits the possible applications and uses of the hydrostatic transmission.

The underlying object of the invention is, for a hydrostatic transmission of the initially indicated type, to extend the range of possible applications and uses.

Said object is achieved by the features of claim 1 or 4. Advantageous developments of the invention are described in the sub-claims.

In the hydrostatic transmission according to the invention according to claim 1, the circuit portion extending between the branches and through the hydraulic motor is longer than half the length of the circuit. In the construction according to the invention also, a sudden reduction of the rate of delivery of the hydraulic pump leads to freewheeling of the hydraulic motor, wherein hydraulic fluid is fed through the bypass line into the delivery line of the hydraulic pump and a damaging underpressure in the delivery line is avoided. An essential distinction from the known construction is, however, that at least half of the hydraulic circuit is included in the motor circuit arising during free-wheeling of the hydraulic motor and therefore improved cooling of the hydraulic fluid partial quantity pumped in the motor circuit occurs as a result of the greater volume and the greater length of the motor circuit. Said advantage is achieved also when only one of the two branches of the bypass line is situated in the vicinity of the hydraulic pump or is integrated with the check valve into the hydraulic pump. Said branch may be the branch of the high-pressure system and/or the branch of the low-pressure system. It is, of course, particularly advantageous when both branches of the bypass line are disposed in the vicinity of the hydraulic pump or are preferably integrated into the hydraulic pump.

Furthermore, in the case of an open circuit, the hydraulic fluid quantity situated in the provided tank is included in said motor circuit when the branch of the low-pressure system branches off from the low-pressure-side working line and/or suction line of the hydraulic pump or the bypass line is directly connected to the tank. In said cases, the features of claim 1 need not be fulfilled because the larger hydraulic fluid quantity situated in the tank contributes towards the desired cooling in the motor circuit. The independent claim 4 is directed towards said alternative solution, which has the same underlying object according to the invention.

The constructions according to the invention are therefore also suitable for applications involving high load forces, in particular for vehicle drives or drives for lifting equipment such as e.g. cranes, excavators and loaders.

As a check valve, a nonreturn valve is eminently suitable, which opens and closes automatically and leads to a simple and economical solution.

The construction according to the invention moreover makes it possible to dispose a cooler and/or a filter in the working lines of the high-pressure system and/or low-pressure system, namely preferably in the region between the hydraulic motor and a high-pressure-side or low-pressure-side branch of the bypass line. Given such a construction, cooling and/or filtering of the hydraulic fluid is guaranteed both during normal operation of the hydrostatic transmission and during free-wheeling of the hydraulic motor.

To avoid a bulky design, it is advantageous to integrate the nonreturn valve and preferably also the associated bypass line into the hydraulic pump. By said means, the design is simplified and a separate bypass line avoided.

Further developments of the invention lead to small constructions, which are economical to manufacture and which i.a. facilitate the maintenance and/or adjustment of the check valve and moreover guarantee trouble-free operation.

The hydrostatic transmission according to the invention is also eminently suitable as a drive for a motor vehicle, in particular a motorcycle, wherein the hydraulic motor is provided for driving the drive wheel of the motor vehicle, e.g. for the latter's front wheel.

There now follows a detailed description of the invention and further advantages achievable thereby with reference to advantageous constructions of several embodiments. The drawings show:

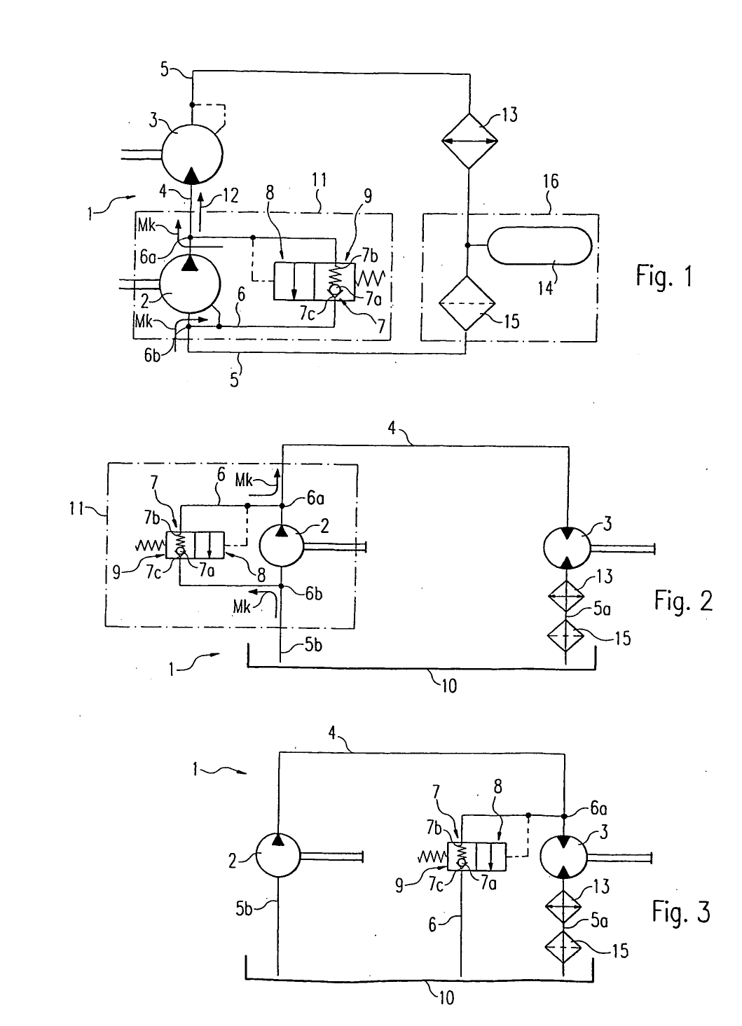

FIG. 1 a diagrammatic view of a hydrostatic transmission according to the invention comprising at least one hydraulic pump and at least one hydraulic motor in a closed circuit;

FIG. 2 an open-circuit hydrostatic transmission according to the invention;

FIG. 3 a modified construction of an open-circuit hydrostatic transmission according to the invention;

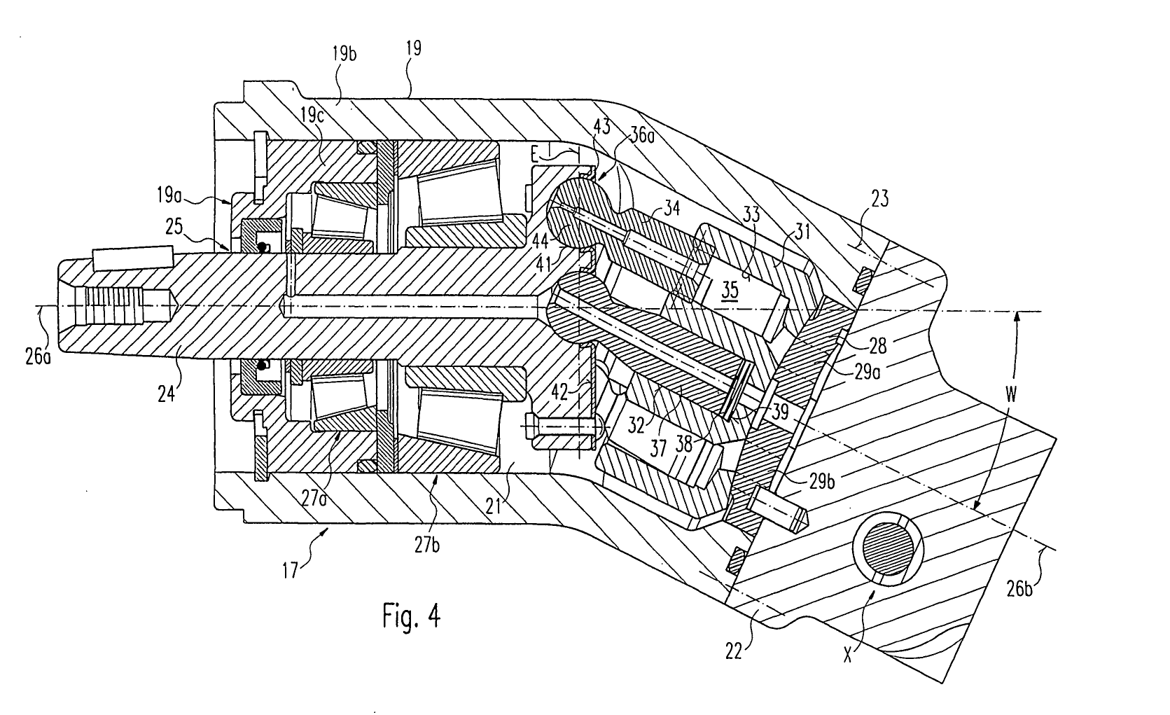

FIG. 4 an axial section of an embodiment of the hydraulic pump in the form of an axial piston engine; and

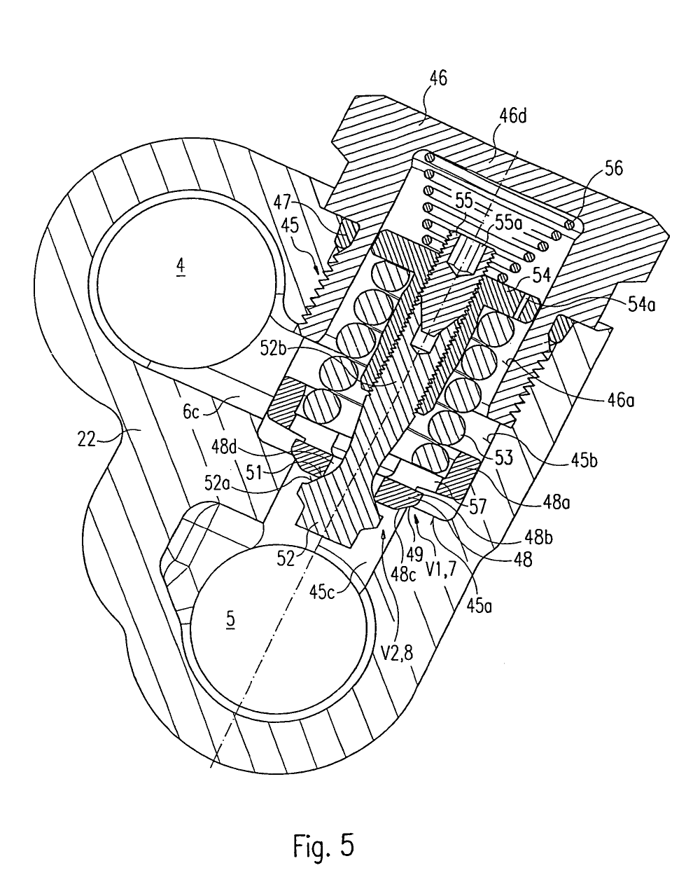

FIG. 5 an enlarged section of the detail denoted by X in FIG. 4.

The main parts of the hydrostatic transmission denoted as a whole by 1 are the hydraulic pump 2, the hydraulic motor 3 and working lines, which connect the latter to one another and of which the working line connecting the output of the hydraulic pump 2 to the input of the hydraulic motor 3 is a delivery line 4 and the working line connecting the output of the hydraulic motor 2 to the input of the hydraulic pump 2 is a return line 5. Associated with the hydraulic pump 2 is a bypass line 6, which is connected to the delivery line 4 and the return line 5. The associated line connections and/or branches are denoted by 6a, 6b.

Disposed in the bypass line 6 is a check valve, preferably a nonreturn valve 7, the valve body of which opens for a flow direction towards the delivery line 4 and closes for a flow direction towards the return line 5. The valve body 7a of the nonreturn valve 7 is biased by a spring 7b towards the provided valve seat 7c.

Further disposed in the bypass line 6 is a pressure-limiting valve 8, which opens the bypass line 6 when the pressure in the delivery line 4 exceeds a predetermined value, so that hydraulic fluid may then flow from the delivery line 4 to the return line 5. The nonreturn valve 7 and the pressure-limiting valve 8 are preferably provided in a parallel arrangement, i.e. given pressures in the delivery line 4 below the predetermined pressure value, the check valve is in operation and, when the pressure value exceeds the predetermined value, the pressure-limiting valve 8 is in operation. In said case, the check valve and the pressure-limiting valve 8 may be integrated into a directional valve, e.g. a two/two-way valve 9, as shown in FIG. 1. In FIG. 1, it is moreover indicated by a dash-dot line 11 enclosing a rectangle that the hydraulic pump 2, the bypass line 6, the check valve and optionally also the pressure-limiting valve 8 may form a unit 11, wherein the bypass line 6 and the valves 7, 8 may be integrated preferably into the unit 11 or into the hydraulic pump 2.

In the return line 5 a cooler 13, a tank and/or accumulator 14 and a filter 15 may be disposed successively in flow direction 12, wherein the accumulator 14 and the filter 15 may, as indicated, be parts of a unit 16.

During operation of the hydrostatic transmission 1 the hydraulic pump 2 is driven by a non-illustrated motor and delivers the hydraulic fluid into the delivery line 4, which extends to the hydraulic motor 3, which is driven by the delivery flow, wherein an operating pressure arises in the delivery line 4 and the delivery quantity flowing through the hydraulic motor 3 is returned in the closed circuit through the cooler 13 and the filter 15 to the hydraulic pump 2. During the previously described normal operation the valves and hence the bypass line 6 are closed.

When the pressure in the delivery line 4 exceeds a specific value, the pressure-limiting valve 8 automatically opens, wherein an appropriate quantity of hydraulic fluid is conveyed through the bypass line 6 from the delivery line 4 in the arrow direction of the pressure-limiting valve 8 to the return line 5, in the sense of a bypass.

When the operating pressure in the delivery line 4 drops below a specific value and/or, in the present embodiment, drops to a value, which is lower than the low pressure in the return line 5, the check valve or the nonreturn valve 7 automatically opens, wherein hydraulic fluid flows from the return line 5 through the bypass 6 into the delivery line 4. By said means a damaging underpressure and consequential cavitation damage is avoided in the delivery line 4 and in the hydraulic motor 5. Such a pressure drop may arise, for example, when the rate of delivery of the hydraulic pump 2 is intentionally or, owing to a defect, unintentionally suddenly reduced, wherein the hydraulic motor on account of the kinetic energy stored therein continues to operate in the sense of free-wheeling and generates the underpressure in the delivery line 4. Another example of such a pressure reduction is when, because of a function reversal, the hydraulic motor 3 assumes the function of a hydraulic pump and the hydraulic pump 2 assumes the function of a hydraulic motor, e.g. in a vehicle drive during downhill travel. In such a case also, the pressure in the delivery line 4 drops dramatically and the previously described disadvantages may arise.

When the pressure in the delivery line 4 drops and the check valve or, here, the nonreturn valve 7 opens, two different flow situations may arise in the region of the hydraulic pump 2 depending on the operating setting of the latter. When the hydraulic pump 2 is a variable displacement pump and a minimum rate of delivery and/or zero is set, during the previously described free-wheeling of the hydraulic motor 3 a so-called motor circuit Mk arises, which bypasses the hydraulic pump 2 and extends substantially only through the bypass line 6 and the part of the main circuit, which connects the branches 6a, 6b of the bypass line 6 disposed downstream and upstream of the hydraulic pump 2 to one another and extends through the hydraulic motor 3.

When, on the other hand, in the previously described example of a function reversal the hydraulic motor 3 assumes the function of a pump, in a hydraulic pump 2, which is set to a rate of delivery, or a fixed displacement motor a motor circuit arises, in which the hydraulic fluid flows both through the pump 2 operating as a motor and through the check valve or nonreturn valve 7.

The circuit portion extending between the line branches 6a, 6b and through the hydraulic motor 3 is greater than half the peripheral length of the circuit comprising the delivery line 4 and the return line 5. In said case, the line branches 6a, 6b may be at an identical or non-identical distance in peripheral direction from the hydraulic pump 2. The relatively large length of said previously described circuit portion is advantageous for several reasons. Firstly, not only the circuit portion extending between the line branches through the hydraulic motor but also the bypass line are relatively long, which naturally also leads to a relatively large partial volume for the hydraulic fluid in the circuit portion and in the bypass line. This improves the cooling during operation because longer flow paths and a greater volume of hydraulic fluid are available. Said construction moreover makes it possible to dispose at least one hydraulic auxiliary unit, e.g. a cooler and/or a filter, in the sub-portion of the delivery line 4 between the hydraulic motor 3 and the upstream branch 6a or preferably between the hydraulic motor 3 and the downstream branch 6b. In said case, it is necessary to ensure that, in the case of a previously described motor circuit, the hydraulic fluid is also supplied to the auxiliary unit, in particular is cooled and/or filtered. This is particularly important in situations where the motor circuit is in operation for an extended period, as is the case e.g. during downhill travel.

The embodiment according to FIG. 2, in which identical or comparable parts are provided with identical reference characters, differ from the previously described embodiment in that, instead of a closed circuit, an open circuit is provided. In other words, a tank 10 for hydraulic fluid is provided, to which a return line portion 5a extends from the hydraulic motor 3 and from which a return line portion 5b extends to the hydraulic pump 2. The bypass line 6 extends from the line branch 6b in the return line portion 5b to the line branch 6a in the delivery line 4. Here too, the cooler 13 and/or the filter 15 may be disposed upstream of the branch 6b, e.g. in the return line portion 5b, in the delivery line 4 or, in particular, in the return line portion 5a. The combination of the construction according to the invention with an open circuit is advantageous because in a tank a larger quantity of hydraulic fluid is available than is the case in a corresponding return line portion and the larger quantity of available hydraulic fluid is capable of absorbing a greater heat capacity and therefore contributes towards effective cooling of the hydraulic fluid flowing through the hydraulic pump 2 and the hydraulic motor 3.

In the embodiments according to FIGS. 1 and 2, the branches 6a, 6b are disposed in the vicinity of the hydraulic pump 2 or are integrated together with the bypass line 6 into the housing and/or the connection part 22.

In the embodiment according to FIG. 3, in which identical or comparable parts are likewise provided with identical reference characters, in a hydrostatic transmission 1 with an open circuit the bypass line 6 is disposed in such a way that it branches off at a line branch 6a disposed in the delivery line 4 and extends directly to the tank 10. In said case, the line branch 6a may be disposed at an optional point of the delivery line 4, e.g. in the vicinity of, or in, the hydraulic pump 2 or in the vicinity of, or in, the hydraulic motor 3. When, in said construction, the pressure in the high-pressure system drops to an appropriate value, the hydraulic fluid then flows directly from the tank 10 through the bypass line 6 to the delivery line 4 and in the latter prevents a damaging pressure drop. The hydraulic fluid in the tank 10 in said case contributes towards the cooling of the hydraulic motor 3 and/or of the circuit portion disposed here the bypass line 6 and the downstream of the branch 6a because the hydraulic fluid situated in the tank 10, owing to its increased volume, has a greater heat capacity and is moreover cooled more intensively than is the case in the circuit lines.

According to FIG. 4 the hydraulic pump 2 is e.g. an inclined-axis axial piston engine denoted as a whole by 17. The axial piston engine 17 comprises a closed housing 18 with an e.g. pot-shaped housing part 19, the housing interior 21 of which is detachably closed by means of a so-called connection part 22, which is fastened by screws 23 (implied in the drawing) to the free edge of the housing part 19. Rotatably mounted in the housing 18 is a driving shaft 24, which penetrates the base wall 19a of the housing part 19 in a feed-through hole 25. In an inclined-axis engine the pot-shaped housing part 19 is kinked or bent in the region of its peripheral wall 19b so that the longitudinal centre lines 26a, 26b of the housing part portions, which are disposed in a bent or kinked manner relative to one another, include an acute angle W. The driving shaft 24 is disposed in the base-side housing part portion and rotatably mounted by means of one or two rolling bearings 27a, 27b as well as being sealed by means of a suitable ring seal.

The base wall 19a may be formed by a closing disk 19c, which is inserted in a sealed manner into the peripheral wall 19b and which the driving shaft 24 penetrates with motional clearance in the feed-through hole 25 and is sealed therein. Lying against the inside of the connection part 22 is a disk cam 28 having two implied control channels 29a, 29b, which lie diametrically opposite one another and extend approximately parallel to the centre line 26b of the disk cam 28 and are connected to the delivery line 4 and the return line 5 (not shown in FIG. 4). Lying against the inside of the disk cam 28 is a cylinder drum 31, which has a coaxial guide bore 32 and a plurality of approximately paraxially extending piston bores 33, which are arranged distributed over the periphery and which at their ends facing the control channels 29a, 29b are connected by tapered connecting channels to the control channels 29a, 29b. The guide bore 32 and the piston bores 33 open out at the end of the cylinder drum 16 remote from the disk cam 14. In the piston bores 33 pistons 34 are mounted so as to be displaceable axially to and fro, preferably also slightly reciprocable, and with their ends facing the disk cam 28 delimit working chambers 35 in the piston bores 33 and with their head ends remote from the disk cam 28 are connected by means of support joints 36a, in particular ball joints, to the driving shaft 24 so as to be capable of swivelling on all sides. The support joints 36a are situated in a bearing plane E, which extends at right angles to the centre line portion 26a and which, because of the housing part portions being disposed at an acute angle relative to one another, extends obliquely relative to the centre line portion 26b.

A central pin 37 is designed in a comparable manner to the pistons 35 and pivotally connected by a support joint 36b to the driving shaft 24 and extends into the guide bore 32, in which it is mounted with slight motional clearance. Disposed between the central pin 37 and the cylinder drum 31 is a compression spring 38, in particular a helical spring, which biases the cylinder drum 31 with a specific axial force towards the disk cam 28. In the present embodiment, the compression spring 38 is arranged in a bore disposed in the central pin 37 and opening out at the end face of the latter and is supported against the base of the bore and acts against an inner shoulder surface 39 of the cylinder drum 31. In the present embodiment, the support joints 36a, 36b are formed in each case by a hemispherical cup 41 in the inner, preferably flat end face 42 of the driving shaft 24 and a return disk 43, which is common to all of the pistons 35 and which engages behind the spherical piston ends 44, thereby preventing their removal from the cups 41. The return disk 43 may be screw-fastened to the inner end face of the driving shaft 24 preferably designed as a flange. The support joint 36b is also designed in a corresponding manner.

Within the framework of the invention the hydraulic pump 2 may also be formed by piston engines of a different design, e.g. by an axial piston engine of a swash-plate design, in which the support joints 36a are disposed in sliding shoes, which are slidingly supported against a swash plate.

In the embodiment according to FIG. 5 a valve combination 9a comprising the nonreturn valve 7 and the pressure-limiting valve 8 is provided, which is disposed in a compact style of construction with coaxial arrangement of two associated valve seats in an externally accessible manner in the housing 18 of the axial piston engine 17, preferably in the connection part 22, as shown in FIG. 4. The valve combination 9a is disposed in a stepped bore 45, which opens out at the outside of the housing 18 and is hermetically sealable by means of a closure part, which is preferably a screw cap 46, which is screwable into an internal thread of the stepped bore 45 and sealed by means of a sealing ring 47. The valve combination 9a comprises a first disk-shaped valve body 48, which cooperates with a valve seat 49 of a first valve V1, wherein the valve seat 49 is formed by the step surface 45a of the stepped bore 45. The valve body 48 comprises a cylindrical guide body 48a, which is guided so as to be displaceable back and forth along the bore axis in the widened bore portion 45b. Formed axially on the guide body 48a is a closing body 48b, which cooperates with the valve seat 49, preferably by means of a conical closing and/or shoulder surface 48c, which in the closed state lies against the step edge. The bore portion 45b communicates with a transverse channel 6c, which extends in the housing 18 and/or connection part 22, is connected to the branch 6a and hence is part of the high-pressure system. The tapered bore portion 45c likewise extends in the housing 18 and/or connection part 22, is connected to the branch 6b and hence is part of the low-pressure system. The valve V1 forms the check and/or nonreturn valve 7. The transverse channel 6c and the stepped bore 45 may form the bypass line 6.

Disposed preferably coaxially in the valve body 48 is a through-hole 48d, of which the hole edge facing the tapered bore portion 45c forms a second valve seat 51, which cooperates with a second valve body 52, which extends with motional clearance through the through-hole 48d, engages with a preferably conical shoulder surface 52a behind the valve seat 51 and is biased by the action of a valve spring 53 towards the valve seat 51. The valve spring 53 in the present embodiment is a helical spring, which is clamped between the valve body 48 and a spring collar 54, which is connected, preferably screw-connected to the portion of the second valve body 53 extending through the through-hole 48d. Thus, by screwing the spring collar 54 forwards or backwards it is possible to adjust the action of the valve spring 53 and hence the closing force of the second valve V2, which forms the pressure-limiting valve 8. In the present construction, the portion of the second valve body 52 extending through the through-hole 48d takes the form of a threaded shank 52b, on which the spring collar 53 is screwed by a sleeve portion, which extends from it in the direction of the first valve body 48 and in which a threaded bore is disposed. For fixing the screw-connection, a lock element, here a threaded bolt 55, is provided, which is screwed into the threaded bore and towards the threaded shank 52b. The threaded pin 55 at its outer end has a tool application element 55a, e.g. a hexagon socket, which is used for the screw connection and locking. The end of the threaded bolt 55 facing the threaded shank 52b is preferably conical or in the shape of a truncated cone and it engages with its conical shape into a correspondingly hollow-cone-shaped recess in the outer end of the threaded shaft 52.

The round spring collar 54 is guided with slight motional clearance in an axially displaceable manner in an internal bore 46a of the screw cap 46. Clamped between the spring collar 54 and the top wall 46d of the screw cap 46 is a further valve spring 56, of which the spring action is weaker than the spring action of the valve spring 53 and which forms a closing spring for the first valve 1 and/or nonreturn valve 7. The first valve body 48, the second valve body 52, the spring collar 54 and the first valve spring 53 form a motional unit, which is guided in an axially displaceable manner in the stepped bore 45 and biased by the valve spring 56 towards the first valve seat 49.

The function of the valve combination 9a is as follows:

When the pressure in the high-pressure system drops to a value equal to or lower than the pressure in the low-pressure system, the opening force exerted by the pressure in the low-pressure system on the closed valve body 48 outweighs the closing force 58 applied by the valve spring 56, with the result that the nonreturn valve 7 opens and hydraulic fluid from the low-pressure system may flow through the nonreturn valve 7 into the high-pressure system. In said case, there is a flow around the first valve body 48 or through the latter in a separate throughflow channel 57. When the pressure in the high-pressure system exceeds the opening pressure value of the nonreturn valve 7, the nonreturn valve 7 automatically closes.

When the pressure in the high-pressure system exceeds a specific value, said pressure produces at the spring collar 54, because of the latter's pressure equalizing bore 54a, an axial opening force, which because of the larger outer effective area is directed inwards, with the result that the valve spring 53 is compressed and the valve body 52 is displaced inwards, wherein the pressure-limiting valve 8 opens and an exchange of pressure from the high-pressure system to the low-pressure system occurs. When the pressure in the high-pressure system drops, the valve spring 53 automatically closes the pressure-limiting valve 8.

The combination valve 9a is accessible in a handling-friendly manner for adjustment purposes. For said purpose, the cap 46 merely has to be removed for the previously described adjustment mechanism to be accessible in a handling-friendly manner. In the open position the combination valve 9a is also very easy to assemble and/or disassemble or maintain.

1. Hydrostatic transmission (1), comprising
a hydraulic pump (2) and
a hydraulic motor (3) connected by working lines to the hydraulic pump (2),
wherein the working lines at the one connection side of the hydraulic pump (2) and hydraulic motor (3) are part of a high-pressure system and at the other connection side are part of a low-pressure system,
wherein a bypass line (6) connecting the high-pressure system to the low-pressure system is provided, which is connected at branches (6a, 6b) to the high-pressure system and the low-pressure system,
wherein disposed in the bypass line (6) is a nonreturn valve (7), which opens the bypass line (6) when the pressure in the high-pressure system drops below the pressure in the low-pressure system,
wherein a pressure-limiting valve (8) is provided, which in the event of a pressure in the high-pressure system exceeding a specific value opens and enables an exchange of pressure from the high-pressure system to the low-pressure system,
and wherein the circuit portion extending between the branches (6a, 6b) and through the hydraulic motor (3) is longer than half the length of the circuit,
characterized in
that the nonreturn valve (7) and the pressure-limiting valve (8) form a valve combination (9a), which is disposed in an externally accessible manner in a receiving bore (45) of the housing (18) of the hydraulic pump (17).

2. Hydrostatic transmission according to claim 1,
characterized in
that it has a closed or open circuit.

3. Hydrostatic transmission (1), comprising
a hydraulic pump (2) and
a hydraulic motor (3) connected by working lines to the hydraulic pump (2),
wherein the working lines at the one connection side of the hydraulic pump (2) and hydraulic motor (3) are part of a high-pressure system and at the other connection side are part of a low-pressure system,
wherein a bypass line (6) connecting the high-pressure system to the low-pressure system is provided, which is connected at branches (6a, 6b) to the high-pressure system and the low-pressure system,
wherein disposed in the bypass line (6) is a nonreturn valve (7), which opens the bypass line (6) when the pressure in the high-pressure system drops below the pressure in the low-pressure system,
wherein the hydrostatic transmission has an open circuit,
wherein the bypass line (6) is connected in the low-pressure system to the working line (5b), which extends from tank (10) to the hydraulic pump (2), or directly to the tank (10),
and wherein associated with the high-pressure system is a pressure-limiting valve (8),
characterized in
that the nonreturn valve (7) and the pressure-limiting valve (8) form a valve combination (9a) and the valve combination (9a) is disposed in an externally accessible manner in a receiving bore (45) of the housing (18) of the hydraulic pump (17).

4. Hydrostatic transmission according to claim 3,
characterized in
that the, in relation to the hydraulic motor (3), downstream branch (6a) and/or the, in relation to the hydraulic motor (3), upstream branch (6b) are/is disposed in the vicinity of the hydraulic pump (2) or are/is integrated into the housing (18) of the latter, preferably are integrated together with the bypass line (6) in the housing (18).

5. Hydrostatic transmission according to one of claims 1 to 4,
characterized in
that the receiving bore (45) is a stepped bore (45), of which the step together with a valve body (48), which is disposed displaceably in the widened longitudinal portion (45b) of the stepped bore (45) and biased by a valve spring (53) towards the step, forms the nonreturn valve (7), and that disposed in the centre of the valve body (48) is a through-hole (48d), the hole edge of which cooperates with a second valve body (52), which is part of the pressure-limiting valve (8).

6. Hydrostatic transmission according to claim 5,
characterized in
that the second valve body (52) is disposed at the side of the first valve body (48) facing the tapered bore portion (45a), penetrates the through-hole (48d) with a valve body shank (52b) and is connected to a spring collar (54), wherein the associated valve spring (53) is disposed between the first valve body (48) and the spring collar (54).

7. Hydrostatic transmission according to claim 6,
characterized in
that the valve body shank (52b) is screw-connected to the spring collar (54) and screw-adjustable by means of an externally accessible tool application element (55a).

8. Hydrostatic transmission according to one of claims 1 to 7,
characterized in
that the valve combination (9a) is covered by a screw cap (46), which preferably together with a bore (46a) forms a guide for the spring collar (54).
